(19) United States
(12) Patent Application Publication
(10) Pub. No.: US 2011/0133423 A1
(43) Pub. Date: Jun. 9, 2011

(54) SUSPENSION ARM AND MANUFACTURING METHOD FOR THE SAME

(75) Inventor: Pil Young Jeong, Bucheon-si (KR)

(73) Assignees: Hyundai Motor Company, Seoul (KR); Kia Motors Corporation, Seoul (KR)

(21) Appl. No.: 12/834,490

(22) Filed: Jul. 12, 2010

(30) Foreign Application Priority Data
Dec. 4, 2009 (KR) 10-2009-0120120
Dec. 4, 2009 (KR) 10-2009-0120121

(51) Int. Cl. B60G 99/00; B29C 41/30

(52) U.S. Cl. 280/124.1; 264/271.1

(57) ABSTRACT

A suspension arm includes a metal ball housing, a metal bushing housing, a metal connecting portion connecting the metal ball housing and the metal bushing housing and a reinforcement member made of synthetic resin material wrapping the metal ball housing, the metal bushing housing and the metal connecting portion.

### CROSS-REFERENCE TO RELATED APPLICATION

The present application claims priority to Korean Patent Application No. 10-2009-0120120 and 10-2009-0120121 filed in the Korean Intellectual Property Office on Dec. 4, 2009, the entire contents of which is incorporated herein for all purposes by this reference.

### BACKGROUND OF THE INVENTION

1. Field of the Invention

The present invention relates to a suspension system for a vehicle. More particularly, the present invention relates to a suspension arm made of metal and synthetic resin material and manufacturing method for the same.

2. Description of Related Art

Generally, a suspension system for a vehicle includes a chassis spring, which connects a vehicle body and an axle and relieves impacts transmitted from ground, a shock absorber, which is designed to smooth out or damp shock impulse, and dissipate kinetic energy, and a stabilizer, which relieves oscillation of a vehicle.

A suspension system may be divided into a front suspension system and a rear suspension system according to mounting position, and the front suspension system connects a frame and an axle to support a vehicle body, absorbs impact of wheels and simultaneously a parts of a steering is mounted thereof.

The front suspension system is mainly divided into a rigid axle suspension and an independent suspension, and recently the independent suspension has been primarily used for a passenger car, and the rigid axle suspension has been used for a heavy vehicle such as a bus or a truck.

The independent suspension is mainly divided into a Wish Bone type and a Strut or Mcpherson Type, and each wheel of the independent suspension is attached to the frame independently, so that a road bump affecting one wheel has no effect on the others.

A suspension system, so called a control arm, is one of main element in the suspension system and connects wheels, braking system and so on to the vehicle body.

The suspension arm requires high rigidity against vibration and lightweight so that materials for the suspension arm are changed from steel to aluminum or plastic and also the suspension arm with high rigidity and lightweight is not cost competitive.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a suspension arm with high rigidity and lightweight at a competitive price and manufacturing method for the same.

In an exemplary embodiment of the present invention, the suspension arm may include a metal ball housing, a metal bushing housing, a metal connecting portion connecting the metal ball housing and the metal bushing housing at both distal ends thereof, and a reinforcement member made of synthetic resin material and wrapping the metal ball housing, the metal bushing housing and the metal connecting portion.

The reinforcement member may be integrally formed together with the metal ball housing, the metal bushing housing and the metal connecting portion through an insert injection molding process, wherein the reinforcement member is monolithically formed together with the metal ball housing, the metal bushing housing and the metal connecting portion through the insert injection molding process.

The metal ball housing and the metal bushing housing may be connected to the metal connecting portion by welding.

The suspension arm further may include a bearing disposed within the metal ball housing, and a ball stud coupled within the bearing, wherein a lower end of the metal ball housing is inwardly bent to cover the bearing such that the bearing is not to be separated from the metal ball housing, wherein the suspension arm further comprises a dust cover covering the ball stud and the reinforcement member, and wherein the reinforcement member covers an engaging portion of the lower end of the metal ball housing and the bearing.

Surfaces of the metal ball housing and metal bushing housing may be knurled for enhancing coupling force with the reinforcement member.

A connection reinforcement hole may be formed to the metal connecting portion for enhancing coupling force with the reinforcement member, wherein a dented portion is formed on the metal connecting portion and the connection reinforcement hole is formed in the dented portion for enhancing coupling force with the reinforcement member.

The metal connecting portion may include a main plate in which a connection reinforcement hole is formed, and a supporting plate formed to a side of the main plate, wherein a dented portion is formed on the main plate and the connection reinforcement hole is formed in the dented portion for enhancing coupling force with the reinforcement member.

A cross section of the main plate and the supporting plate may be formed as an inverse “U” shape, wherein a lower end of the supporting plate is bent and wherein the reinforcement member comprises an internal reinforcement member that is stuck to inside of the main plate and the supporting plate, and an upper reinforcement member that is stuck to outside of the main plate and connected to the internal reinforcement member through the connection reinforcement hole.

The reinforcement member may further include a side reinforcement member that connects the upper reinforcement member and the internal reinforcement member along an outer surface of the supporting plate, wherein the side reinforcement member is formed as pluralities.

The reinforcement member may be integrally formed together with the metal ball housing, the metal bushing housing and the metal connecting portion through an insert injection molding process.

In another exemplary embodiment of the present invention, a manufacturing method for a suspension arm may include preparing a metal portion comprising a metal ball housing, a metal bushing housing and a metal connecting portion connecting the metal ball housing and the metal bushing housing at both distal ends thereof, disposing the metal portion in a mold by fixing internal sides of the metal ball housing and the metal bushing housing to the mold, and supplying synthetic resin for wrapping the metal portion.

The manufacturing method may further include connecting a ball stud and a bearing, forcefully inserting the ball stud and the bearing into the metal ball housing, and caulking an end of the metal ball housing.

As described above, a suspension arm according to an exemplary embodiment of the present invention can be formed by metal material and synthetic resin material so that the suspension arm may have high rigidity and lightweight at a competitive price.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary suspension arm according to the present invention.

FIG. 2 is a perspective view of a metal ball housing, a metal bushing housing and a metal connecting portion of an exemplary suspension arm according to the present invention.

FIG. 3 is a perspective view of a reinforcement member of the exemplary suspension arm according to the present invention.

FIG. 4 is a cross-sectional view along the line IV-IV of FIG. 1.

FIG. 5 is a top plan view of a bushing of the exemplary suspension arm according to the present invention.

FIG. 6 is a perspective view of a metal bushing housing of the exemplary suspension arm according to the present invention.

FIG. 7 is a cross-sectional view along the line VII-VII of FIG. 1.

FIG. 8 is a perspective view of an exemplary suspension arm according to the present invention.

FIG. 9 is a perspective view of an exemplary variation according to the present invention.

FIG. 10 is a drawing showing manufacturing a reinforcement member according to the present invention.

FIG. 11 is a flowchart showing manufacturing method for the exemplary suspension arm according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will hereinafter be described in detail with reference to the accompanying drawings.

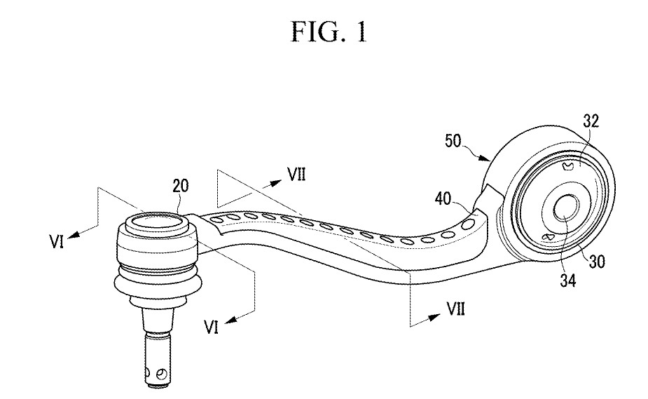

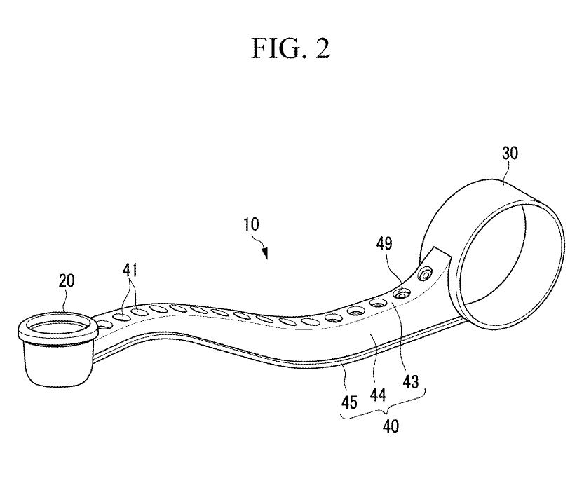

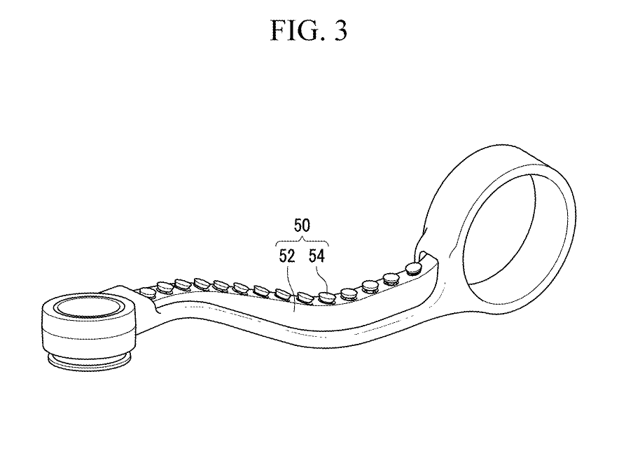

FIG. 1 is a perspective view of a suspension arm, FIG. 2 is a perspective view of a metal ball housing, a metal bushing housing and a metal connecting portion of a suspension arm and FIG. 3 is a perspective view of a reinforcement member of the suspension arm according to the first exemplary embodiment of the present.

Referring to FIG. 1 to FIG. 3, a suspension arm according to the first exemplary embodiment of the present invention includes a metal ball housing 20, a metal bushing housing 30, a metal connecting portion 40 connecting the metal ball housing 20 and the metal bushing housing 30 and a reinforcement member 50 made of synthetic resin material wrapping the metal ball housing 20, the metal bushing housing 30 and the metal connecting portion 40.

The metal ball housing 20, the metal bushing housing 30 and the metal connecting portion 40 form a metal portion 10.

The reinforcement member 50 is integrally formed together with the metal ball housing 20, the metal bushing housing 30 and the metal connecting portion 40 through an insert injection molding process.

The metal ball housing 20 and the metal bushing housing 30 are connected to the metal connecting portion 40 by welding or monolithically formed.

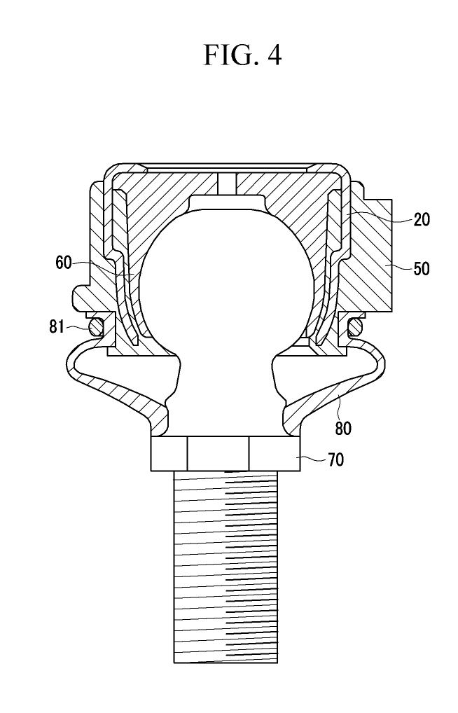

FIG. 4 is a cross-sectional view along the line IV-IV of FIG. 1.

Referring to FIG. 4, the suspension arm further includes a bearing 60 that is disposed within the metal ball housing 20 and a ball stud 70 that disposed within the bearing 60, wherein an end of the metal ball housing 20 is inwardly bent for the bearing 60 not to be separated from the metal ball hosing 20.

A dust cover ring 81 is coupled to a dust cover 80 which covers the ball stud 70 and the reinforcement member 50.

The ball stud 70 is connected to a wheel (not shown), the bearing 60 permits the ball stud 70 to rotate smoothly and the bent end of the metal ball housing 20 prevents the bearing 60 from separating.

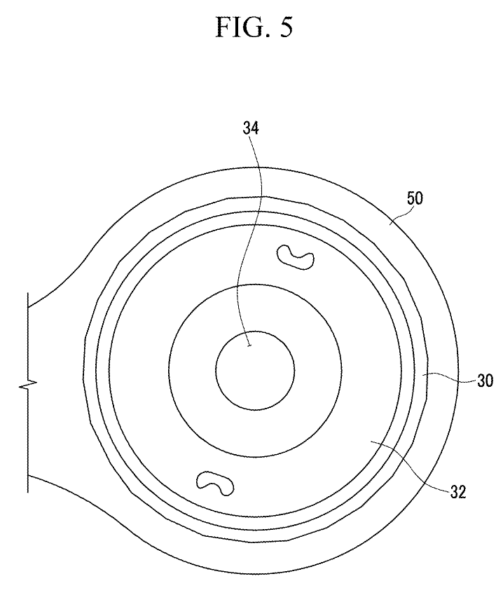

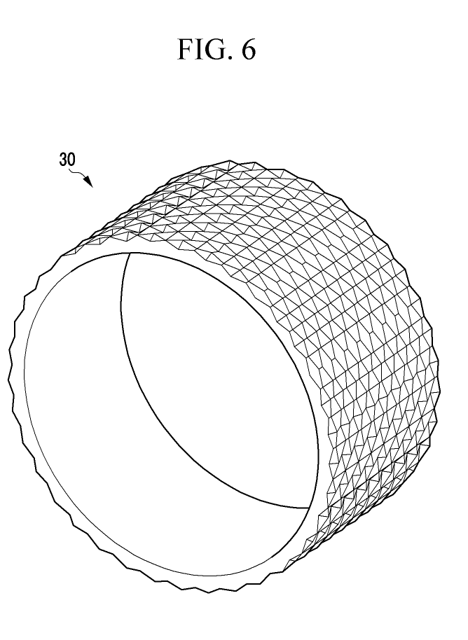

FIG. 5 is a top plan view of a bushing of the suspension arm according to the first exemplary embodiment of the present invention and FIG. 6 is a perspective view of a metal bushing housing of the suspension arm according to the first exemplary embodiment of the present invention.

A surface of the metal ball housing 30 is knurled for enhancing coupling force with the reinforcement member 50, and it is not described in the drawings, however, a surface of the metal ball housing 20 may be knurled.

The metal bushing housing 30 (also the metal ball housing 20) is made of a metal material, and the reinforcement member 50 is made of synthetic resin material, so that coupling force between the metal bushing housing 30 and the reinforcement member 50 is not sufficient. However, the knurled surface of the metal ball housing 30 can enhance coupling force with the reinforcement member 50.

A bushing 32 is disposed within the metal bushing housing 30 and a bushing hole 34 is formed to the bushing. And a vehicle body (not shown) is connected to the suspension arm through the bushing hole 34.

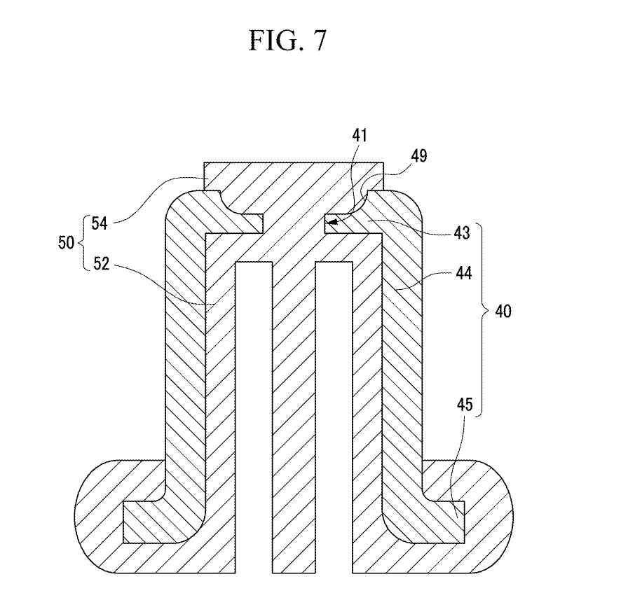

FIG. 7 is a cross-sectional view along the line VII-VII of FIG. 1.

Referring to FIG. 2, FIG. 3 and FIG. 7, a connection reinforcement hole 41 is formed to the metal connecting portion 40 for enhancing coupling force with the reinforcement member 50, wherein the reinforcement member 50 is inserted into the connecting reinforcement hole 41.

The metal connecting portion 40 includes a main plate 43 that the connection reinforcement hole 41 is formed and a supporting plate 44 formed to a side of the main plate 43.

A cross section of the main plate 43 and the supporting plate 44 is formed as inverse “U” shape so that buckling can be prevented.

An end of the supporting plate 45 is bent so that buckling can be prevented either.

The reinforcement member 50 includes an internal reinforcement member 52 that is stuck to inside of the main plate 43 and the supporting plate 44 and an upper reinforcement member 54 that is stuck to outside of the main plate 43.

In the suspension arm according to the first exemplary embodiment of the present invention, the internal reinforcement member 52 and the upper reinforcement member 54 of the reinforcement member 50 are connected through the connection reinforcement hole, so that coupling force between the metal portion 10 and the reinforcement member 50 can be enhanced and buckling of the metal portion 10 can be prevented.

In another exemplary embodiment of the present invention, the main plate 43 may include a dented portion 49 to which the connection reinforcement hole 41 is formed thereto to increase a contact surface between the upper reinforcement member 54 and the main plate 43.

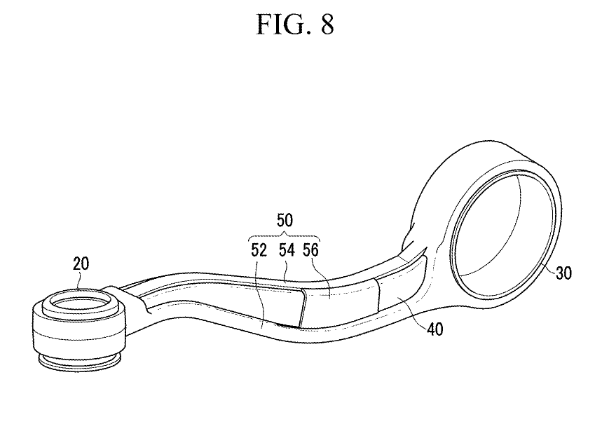

FIG. 8 is a perspective view of a suspension arm according to the second exemplary embodiment of the present invention.

Hereinafter, for better comprehension and ease of description, the same reference number will indicate the same element.

Referring to FIG. 8, in the second exemplary embodiment of the present invention, the reinforcement member 50 includes a side reinforcement member 56 that connects the upper reinforcement member 54 and the internal reinforcement member 52.

Buckling can be expected to happen in the middle of the metal portion 10, so that the side reinforcement member 56 is formed to the middle of the metal portion 10 to enhance rigidity.

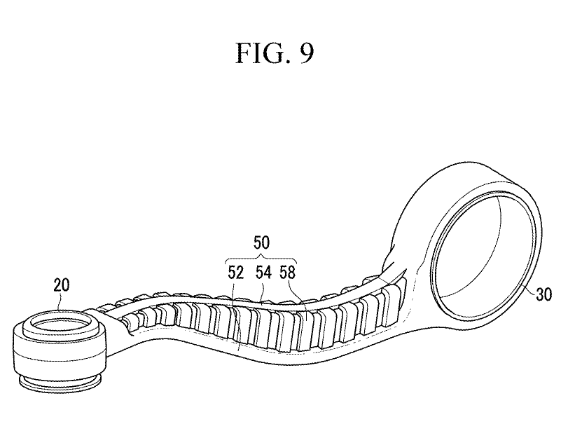

FIG. 9 is a perspective view of an exemplary variation according to the second exemplary embodiment of the present invention.

In the exemplary variation according to the second exemplary embodiment of the present invention, the side reinforcement member 58 is formed as pluralities along the metal connecting portion 40.

The suspension of the exemplary variation according to the second exemplary embodiment of the present invention can minimize possibility of buckling such as the suspension arm according to the second exemplary embodiment of the present invention,

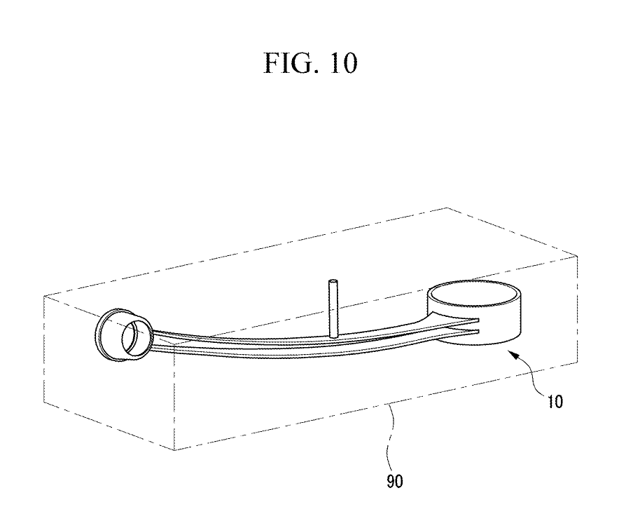

FIG. 10 is a drawing showing manufacturing a reinforcement member according to an exemplary embodiment of the present invention.

As shown in FIG. 10, the metal portion 10 is fixed to a mold 90, and then the metal portion 10 and the reinforcement member 50 are integrally formed by inserting synthetic resin into the mold 90. In this process, the metal portion 10 is disposed to the mold 90 by fixing internal sides of the metal ball housing 20 and the metal bushing housing 30 to the mold 90, and then the synthetic resin is supplied into the mold 90.

The suspension arm according to exemplary embodiments of the present invention may form the metal portion 10 and the reinforcement member 50 integrally by injection molding with high rigidity and lightweight at a competitive price.

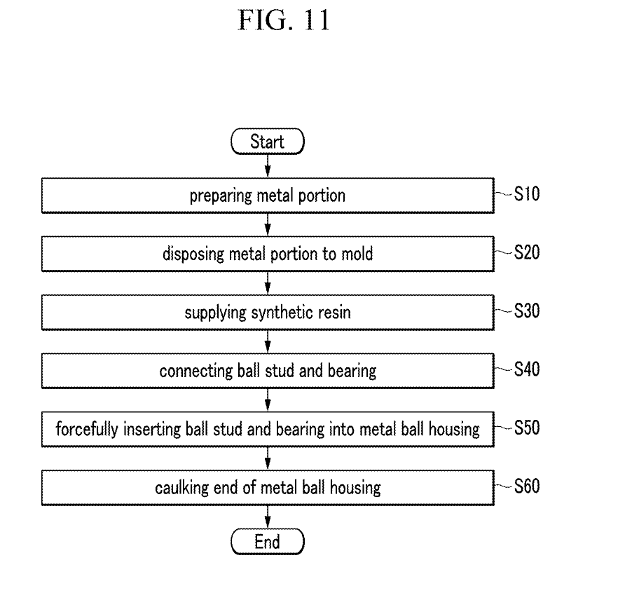

FIG. 11 is a flowchart showing manufacturing method for the suspension arm according to the exemplary embodiments of the present invention.

Referring to FIG. 11, a manufacturing method for a suspension arm according to an exemplary embodiment of the present invention includes preparing the metal portion 10 including the metal ball housing 20, the metal bushing housing 30 and the metal connecting portion 40 connected with the metal ball housing 30 and the metal bushing housing 30 (S10), disposing the metal portion 10 to the mold 90 by fixing the internal sides of the metal ball housing 20 and the metal bushing housing 30 to the mold 90 (S20) and supplying synthetic resin for wrapping the metal portion 10 (S30).

The method further includes connecting the ball stud 70 and the bearing 60 (S40), forcefully inserting the ball stud 70 and the bearing 60 into the metal ball housing 20 (S50) and caulking the end of the metal ball housing 20 (S60).

According to the exemplary embodiment of the present invention, the suspension arm can be made of metal material and synthetic resin material with high rigidity and lightweight at a competitive price.

For convenience in explanation and accurate definition in the appended claims, the terms “lower,” “internal” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A suspension arm comprising:
a metal ball housing;
a metal bushing housing;
a metal connecting portion connecting the metal ball housing and the metal bushing housing at both distal ends thereof; and
a reinforcement member made of synthetic resin material and wrapping the metal ball housing, the metal bushing housing and the metal connecting portion.

2. The suspension arm of claim 1, wherein the reinforcement member is integrally formed together with the metal ball housing, the metal bushing housing and the metal connecting portion through an insert injection molding process.

3. The suspension arm of claim 2, wherein the reinforcement member is monolithically formed together with the metal ball housing, the metal bushing housing and the metal connecting portion through the insert injection molding process.

4. The suspension arm of claim 1, wherein the metal ball housing and the metal bushing housing are connected to the metal connecting portion by welding.

5. The suspension arm of claim 1, wherein the suspension arm further comprises:
a bearing disposed within the metal ball housing; and
a ball stud coupled within the bearing;
wherein a lower end of the metal ball housing is inwardly bent to cover the bearing such that the bearing is not to be separated from the metal ball housing.

6. The suspension arm of claim 5, wherein the suspension arm further comprises a dust cover covering the ball stud and the reinforcement member, and wherein the reinforcement member covers an engaging portion of the lower end of the metal ball housing and the bearing.

7. The suspension arm of claim 1, wherein surfaces of the metal ball housing and metal bushing housing are knurled for enhancing coupling force with the reinforcement member.

8. The suspension arm of claim 1, wherein a connection reinforcement hole is formed to the metal connecting portion for enhancing coupling force with the reinforcement member.

9. The suspension arm of claim 8, wherein a dented portion is formed on the metal connecting portion and the connection reinforcement hole is formed in the dented portion for enhancing coupling force with the reinforcement member.

10. The suspension arm of claim 1, wherein the metal connecting portion comprises:
a main plate in which a connection reinforcement hole is formed; and
a supporting plate formed to a side of the main plate.

11. The suspension arm of claim 10, wherein a dented portion is formed on the main plate and the connection reinforcement hole is formed in the dented portion for enhancing coupling force with the reinforcement member.

12. The suspension arm of claim 10, wherein a cross section of the main plate and the supporting plate is formed as an inverse “U” shape.

13. The suspension arm of claim 12, wherein a lower end of the supporting plate is bent.

14. The suspension arm of claim 12, wherein the reinforcement member comprises:
an internal reinforcement member that is stuck to inside of the main plate and the supporting plate; and
an upper reinforcement member that is stuck to outside of the main plate and connected to the internal reinforcement member through the connection reinforcement hole.

15. The suspension arm of claim 14, wherein the reinforcement member further comprises a side reinforcement member that connects the upper reinforcement member and the internal reinforcement member along an outer surface of the supporting plate.

16. The suspension arm of claim 15, wherein the side reinforcement member is formed as pluralities.

17. The suspension arm of claim 14, wherein the reinforcement member is integrally formed together with the metal ball housing, the metal bushing housing and the metal connecting portion through an insert injection molding process.

18. A manufacturing method for a suspension arm comprising:
preparing a metal portion comprising a metal ball housing, a metal bushing housing and a metal connecting portion connecting the metal ball housing and the metal bushing housing at both distal ends thereof;
disposing the metal portion in a mold by fixing internal sides of the metal ball housing and the metal bushing housing to the mold; and
supplying synthetic resin for wrapping the metal portion.

19. The manufacturing method of claim 18, further comprising:
connecting a ball stud and a bearing;
forcefully inserting the ball stud and the bearing into the metal ball housing; and
caulking an end of the metal ball housing.
